(19) United States
(12) Patent Application Publication
(10) Pub. No.: US 2012/0243919 A1
(43) Pub. Date: Sep. 27, 2012

(54) FIXING DEVICE AND IMAGE FORMING APPARATUS PROVIDED WITH THE SAME

(75) Inventors: Masaru Takagi, Osaka-shi (JP); Syouji Kouda, Osaka-shi (JP); Kohshiroh Tomimori, Osaka-shi (JP)

(73) Assignee: KYOCERA MITA CORPORATION, Osaka-shi (JP)

(21) Appl. No.: 13/428,195

(22) Filed: Mar. 23, 2012

(30) Foreign Application Priority Data
Mar. 25, 2011 (JP) 2011-068026
May 30, 2011 (JP) 2011-120283

(51) Int. Cl. G03G 15/20

(52) U.S. Cl. 399/323

(57) ABSTRACT

A fixing device includes a first and a second rollers which form a fixing nip portion, a separating member for sheets, a supporting mechanism and a contact portion. The separating member is displaced between a first posture in which the tip of the separating member is close to the circumferential surface of the first roller and a second posture in which the tip is distant from that. The contact portion forms a gap between the tip of the separating member and the circumferential surface of the first roller. The supporting mechanism includes a pair of supporting members arranged near the opposite ends of the first roller, pivot members extending from the separating members and serving as a pivot of rotation of the separating member, and long holes which are provided at the opposite ends of the separating member and into which the pivot members are inserted.

This application is based on Japanese Patent Application Serial No. 2011-068026 filed with the Japan Patent Office on Mar. 25, 2011 and Japanese Patent Application Serial No. 2011-120283 filed with the Japan Patent Office on May 30, 2011, the contents of which are hereby incorporated by reference.

### BACKGROUND

The present disclosure relates to a fixing device and an image forming apparatus.

In a fixing device provided in an image forming apparatus, a fixing roller and a pressure roller are pressed in contact to form a fixing nip portion. When passing the fixing nip portion, a sheet is pressed and heated, whereby a toner image on the sheet is fixed.

A sheet may adhere to the circumferential surface of the fixing roller by being heated when passing the fixing nip portion. In this case, the sheet wraps around the fixing roller after passing the fixing nip portion.

There is known a fixing device in which a separating member for separating a sheet wrapping around a fixing roller from the fixing roller to prevent such wrapping around the fixing roller is arranged at a position downstream of the fixing roller in a rotation direction and near the fixing roller.

The above separating member is generally a flat plate extending in an axial direction of the fixing roller. If the tip of the flat plate is constantly in contact with the circumferential surface of the fixing roller, the circumferential surface of the fixing roller may be damaged. If a toner image on a sheet is fixed with the circumferential surface of the fixing roller damaged, a mark of damage may be left in the toner image on the sheet. Thus, a gap of a predetermined distance is formed between the tip of the flat plate and the circumferential surface of the fixing roller. This gap is formed by arranging the flat plate tip along the fixing roller so that the flat plate tip and the axial direction of the fixing roller are parallel.

If the gap distance is too small, a gap part may be clogged with paper powder. On the other hand, if the gap distance is too large, a sheet separation property is reduced. Thus, the gap distance needs to be set at an appropriate value which is neither too small nor too large.

However, depending on the twist of the flat plate or positional alignment of the flat plate and the fixing roller, the flat plate tip may not be held in parallel with the axial direction of the fixing roller. In this case, a distance between the flat plate tip and the circumferential surface of the fixing roller cannot be kept constant.

An object of the present disclosure is to provide a fixing device and an image forming apparatus capable of appropriately securing a gap between a separating member and a roller.

### SUMMARY

One aspect of the present disclosure is directed to a fixing device, including a first and a second rollers, a separating member and a supporting mechanism. The first and second rollers form a fixing nip portion and fix a toner image formed on a sheet passing the fixing nip portion by heating and pressing the sheet. The separating member is a plat-like member arranged downstream of the fixing nip portion in a rotation direction of the first roller, adapted to separate the sheet having passed the fixing nip portion while wrapping around the first roller from the first roller and extending in an axial direction of the first roller. The supporting mechanism rotatably supports the separating member such that the separating member is displaced between a first posture in which the tip of the separating member is close to the circumferential surface of the first roller and a second posture in which the tip is distant from the circumferential surface of the first roller. A passage area where the sheet passes and a non-passage area where the sheet does not pass are set on the circumferential surface of the first roller. The separating member includes a contact portion which comes into contact with the non-passage area to form a gap of a predetermined distance between the tip of the separating member and the circumferential surface of the first roller. The contact portion is a touching member which is so mounted on the opposite ends of the plate-like member as to at least partly project toward the circumferential surface of the first roller. The supporting mechanism includes a pivot member which serves as a pivot of rotation of the separating member and a long hole which is formed in the separating member and into which the pivot member is inserted.

Another aspect of the present disclosure is directed to an image forming apparatus, including the above fixing device, an image obtaining unit for obtaining image data of a document; and an image forming unit for forming image data obtained by the image obtaining unit on a sheet.

These and other objects, features and advantages of the present disclosure will become more apparent upon reading the following detailed description along with the accompanying drawings.

### BRIEF DESCRIPTION OF DRAWINGS

FIG. 1 is a sectional view showing an example of the overall construction of an image forming apparatus according to one embodiment of the present disclosure,

FIG. 2 is a view showing an example of an essential construction of a fixing unit,

FIG. 3 is a view showing an example of a positional relationship between touching members and a fixing roller,

FIGS. 4A and 4B are perspective views respectively showing a front side of a separating member and a rear side of the separating member,

FIGS. 5A and 5B are perspective views of the touching member, wherein FIG. 5A shows a mounting surface side on the separating member and FIG. 5B shows a contact surface side with a fixing belt,

FIG. 6 is a perspective view of the fixing unit when viewed from behind,

FIG. 7 is a perspective view of the fixing unit when viewed from front,

FIG. 8 is a perspective view showing an example of a mounting mode of the separating member on a supporting member,

FIG. 9 is a view showing the separating member in a second posture,

FIG. 10 is a view showing the separating member in a first posture, and

FIG. 11 is a view showing an example of a mounting mode of a biasing spring.

### DETAILED DESCRIPTION

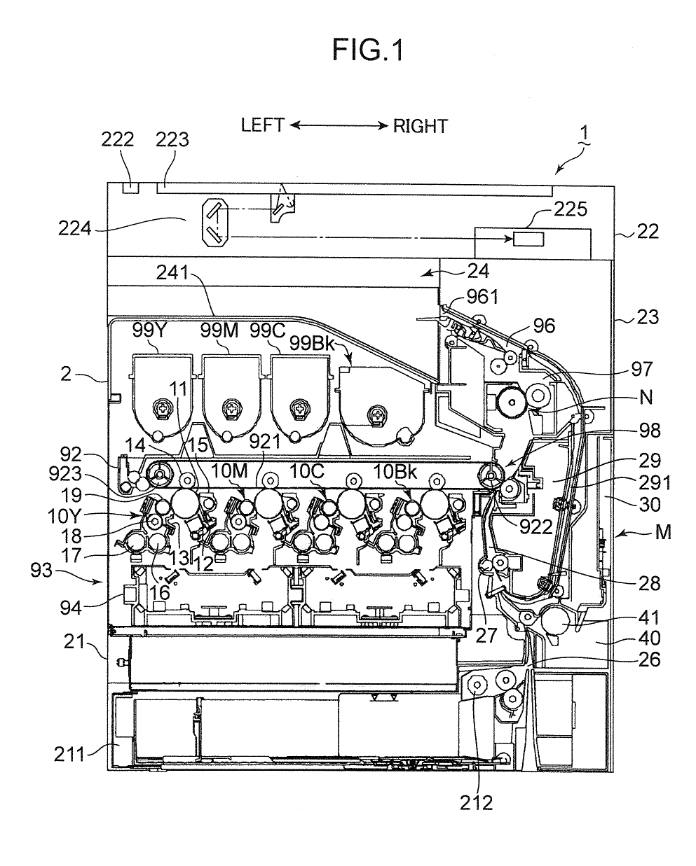

Hereinafter, an embodiment of the present disclosure is described using the drawings. FIG. 1 is a sectional view showing an example of the overall construction of an image forming apparatus 1 including a fixing device 97 according to one embodiment of the present disclosure. Although a copier of an internal discharge type is illustrated as the image forming apparatus 1 here, the image forming apparatus may be a printer, a facsimile machine or a complex machine of these.

The image forming apparatus 1 includes an apparatus main body 2 having a substantially rectangular parallelepipedic housing structure and including an internal space. The apparatus main body 2 performs an image forming process on a sheet. The apparatus main body 2 includes a substantially rectangular parallelepipedic lower housing 21, a substantially rectangular parallelepipedic upper housing 22 arranged above the lower housing 21, and a coupling housing 23 coupling the lower housing 21 and the upper housing 22. Various devices for image formation are housed in the lower housing 21, and various devices for optically reading a document image are housed in the upper housing 22. The internal space enclosed by the lower housing 21, the upper housing and the coupling housing 23 serves as an internal discharge portion 24 capable of storing a sheet after image formation. The coupling housing 23 is arranged at a side of the right surface of the apparatus main body 2 and provided with a sheet discharge port 961 for discharging a sheet to the internal discharge portion 24.

The internal space utilized as the internal discharge portion 24 is exposed to the outside at the front surface and the left surface of the apparatus main body 2. A user can take out a sheet after image formation from the internal discharge portion 24 by inserting his or her hand through these exposed parts. A bottom surface 241 of the internal space is defined by the upper surface of the lower housing 21 and sheets discharged from the sheet discharge port 961 are to be stacked thereon.

A sheet cassette 211 for storing sheets on which an image forming process is to be performed is mounted in the lower housing 21. The sheet cassette 211 can be withdrawn forward from the front surface of the lower housing 21 (apparatus main body 2). This sheet cassette 211 is a cassette provided for automatic sheet feeding.

A multi-tray unit M used to manually feed a sheet by the user is attached to the right surface of the apparatus main body 2. The multi-tray unit M includes a sheet tray 30 on which a sheet to be manually fed is to be placed and a feeding unit 40 for conveying the manually fed sheet to an image forming station 93 in the lower housing 21. The sheet tray 30 has a lower end portion thereof openably and closably attached to the lower housing 21, and is closed when not in use. In the case of manual sheet feeding, the user opens the sheet tray 30 and places a sheet thereon.

Toner containers 99Y, 99M, 99C and 99Bk, an intermediate transfer unit 92, the image forming station 93, an exposure unit 94 and the above sheet cassette 211 are housed in this order from above in the lower housing 21.

The image forming station 93 includes four image forming units 10Y, 10M, 10C and 10Bk for forming toner images of yellow (Y), magenta (M), cyan (C) and black (Bk) to form a full color toner image. Each of the image forming units 10Y, 10M, 10C and 10Bk includes a photoconductive drum 11, and a charger 12, a developing device 13, a primary transfer roller 14 and a cleaner 15 arranged around the photoconductive drum 11.

The photoconductive drum 11 rotates about its shaft and has an electrostatic latent image and a toner image formed on its circumference surface. The charger 12 uniformly charges the circumferential surface of the photoconductive drum 11. The charged circumferential surface of the photoconductive drum 11 is exposed to light by the exposure unit 94 to form an electrostatic latent image.

The developing device 13 supplies toner to the circumferential surface of the photoconductive drum 11 to develop an electrostatic latent image formed on the photoconductive drum 11. The developing device 13 is for two-component developer and includes agitating rollers 16, 17, a magnetic roller 18 and a developing roller 19. The agitating rollers 16, 17 convey the two-component developer in a circulating manner while agitating it, thereby charging the toner. A two-component developer layer is carried on the circumferential surface of the magnetic roller 18, and a toner layer formed by the transfer of the toner due to a potential difference between the magnetic roller 18 and the developing roller 19 is carried on the circumferential surface of the developing roller 19. The toner on the developing roller 19 is supplied to the circumferential surface of the photoconductive drum 11 to develop the electrostatic latent image.

The primary transfer roller 14 forms a primary transfer nip portion together with the photoconductive drum 11 with an intermediate transfer belt 921 of the intermediate transfer unit 92 sandwiched therebetween, and primarily transfers a toner image on the photoconductive drum 11 to the intermediate transfer belt 921. The cleaner 15 cleans the circumferential surface of the photoconductive drum 11 after the transfer of the toner image.

The toner container 99Y for yellow, the toner container 99M for magenta, the toner container 99C for cyan and the toner container 99Bk for black are respectively for storing the toners of the respective colors, and supply the toners of the respective colors to the developing devices 13 of the image forming units 10Y, 10M, 10C and 10Bk corresponding to the respective colors Y, M, C and Bk via unillustrated supply paths.

The exposure unit 94 constitutes a part of the image forming system 93. The exposure unit 94 includes various optical devices such as a light source, a polygon mirror, a reflecting mirror and a deflecting mirror, and irradiates the circumferential surfaces of the photoconductive drums 11 provided in the respective image forming units 10Y, 10M, 10C and 10Bk with beams based on image data of a document image to form electrostatic latent images.

The intermediate transfer unit 92 includes the intermediate transfer belt 921, a drive roller 922 and a driven roller 923. Toner images from a plurality of photoconductive drums 11 are superimposed on the intermediate transfer belt 921 (primary transfer). The superimposed transferred toner images are secondarily transferred to a sheet supplied from the sheet cassette 211 or the sheet tray 30 in a secondary transfer unit 98.

The sheet cassette 211 stores a sheet stack composed of a plurality of sheets stacked one over another. A pickup roller 212 is arranged above the right end of the sheet cassette 211. The uppermost sheet of the sheet stack in the sheet cassette 211 is picked up one by one and carried into a carry-in conveyance path 26 by driving the pickup roller 212. On the other hand, a sheet placed on the sheet tray 30 is carried into the carry-in conveyance path 26 by driving a feed roller 41 of the feeding unit 40.

A sheet conveyance path 28 extending to the discharge port 961 via the secondary transfer unit 98, the fixing unit (fixing device) 97 and a discharge unit 96 is provided downstream of the carry-in conveyance path 26. An upstream part of the sheet conveyance path 28 is formed between an inner wall formed in the lower housing 21 and an inner wall forming the inner side wall of a reversing conveying unit 29. Note that the outer side surface of the reversing conveying unit 29 forms one side of a reversing conveyance path 291 for reversing and conveying a sheet at the time of duplex printing. A pair of registration rollers 27 are arranged upstream of the secondary transfer unit 98 in the sheet conveyance path 28. A sheet is temporarily stopped by the pair of registration rollers 27 and fed to the secondary transfer unit 98 at a predetermined timing for image transfer after a skew correction.

The fixing unit 97 and the discharge unit 96 are housed in the coupling housing 23. The fixing unit 97 performs a fixing process by heating and pressing a sheet having a toner image secondarily transferred in the secondary transfer unit 98 in a fixing nip portion N. A sheet with a fixed color image is discharged toward the internal discharge portion 24 through the discharge port 961 by the discharge unit 96 arranged downstream of the fixing unit 97.

A first contact glass 222 and a second contact glass 223 are mounted in the upper surface of the upper housing 22. The first contact glass 222 is provided to read a document sheet automatically fed from an automatic document feeder (ADF; not shown) when the ADF is arranged atop the upper housing 22. The second contact glass 223 is provided to read a manually placed document sheet.

A scanning mechanism 224 for optically reading document information and an imaging device 225 (image obtaining unit) are housed in the upper housing 22. The scanning mechanism 224 includes a light source, a moving carriage, a reflecting mirror and the like and introduces reflected light from a document to the imaging device 225. The imaging device 225 obtains image data of a document by photoelectrically converting the reflected light into an analog electrical signal.

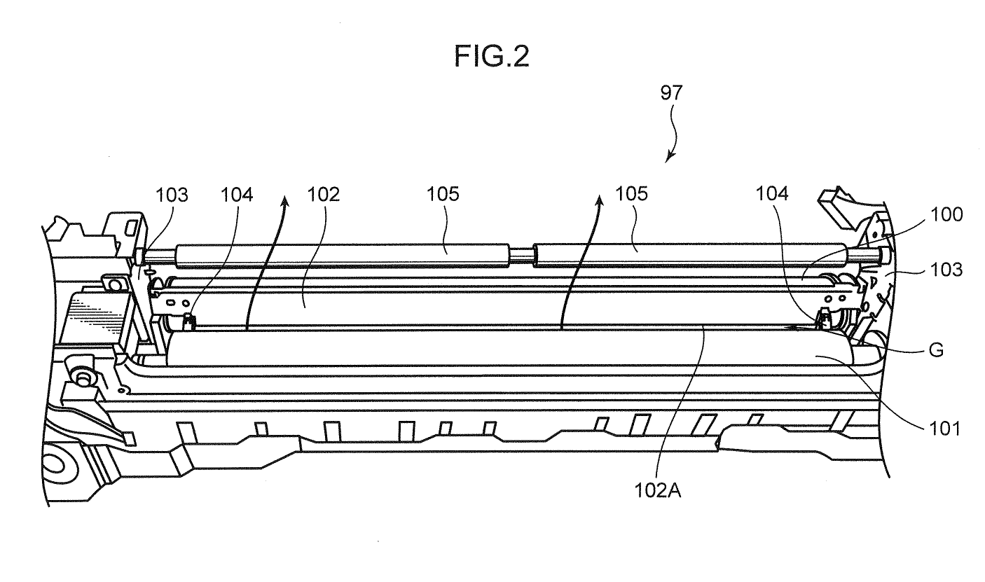

The detailed construction of the fixing unit 97 is described below. FIG. 2 is a view showing an example of an essential construction of the fixing unit 97. In the fixing unit 97, a fixing roller (first roller) 100 and a pressure roller (second roller) 101 are arranged and these rollers are pressed in contact to form the fixing nip portion N.

A sheet having a toner image transfer thereto is conveyed in a direction indicated by thick solid-line arrows in FIG. 2 in the fixing unit 97. When passing the fixing nip portion N, the sheet is heated by the fixing roller 100 and pressed by the pressure roller 101 in the fixing nip portion N. In this way, the toner image is fixed to the sheet.

In the fixing unit 97 constructed as described above, a separating member 102 is arranged downstream of the fixing nip portion N in a sheet conveying direction. The separating member 102 is a member for preventing a sheet S having passed the fixing nip portion N from adhering to and wrapping around the circumferential surface of the fixing roller 100. That is, by heating applied when the sheet passes the fixing nip portion N, a toner image T on the sheet S is melted and adheres to the circumferential surface of the fixing roller 100, whereby the sheet S may wrap around the fixing roller 100. To prevent this wrapping, the separating member 102 separates the sheet S from the fixing roller 100.

A base end side of the separating member 102 is supported by a pair of supporting members 103 arranged near the opposite ends of the fixing roller 100. The separating member 102 is a thin plate-like member extending in an axial direction of the fixing roller 100. A gap G of a predetermined distance is secured between a tip portion 102A of the separating member 102 facing the circumferential surface of the fixing roller 100 and the circumferential surface of the fixing roller 100.

When the sheet having passed the fixing nip portion X reaches the gap G while wrapping around the fixing roller 100, the leading end thereof comes into contact with the tip portion 102A of the separating member 102. In this way, this sheet is separated from the fixing roller 100. Note that a margin area where no toner image is transferred is generally present in the leading end of the sheet S in the conveying direction, and the leading end does not adhere to the fixing roller 100. Accordingly, even if the sheet S wraps around the fixing roller 100, the leading end thereof in the conveying direction is lifted from the circumferential surface of the fixing roller 100, the aforementioned separation is possible even if the tip portion 102A is not in contact with the circumferential surface of the fixing roller 100.

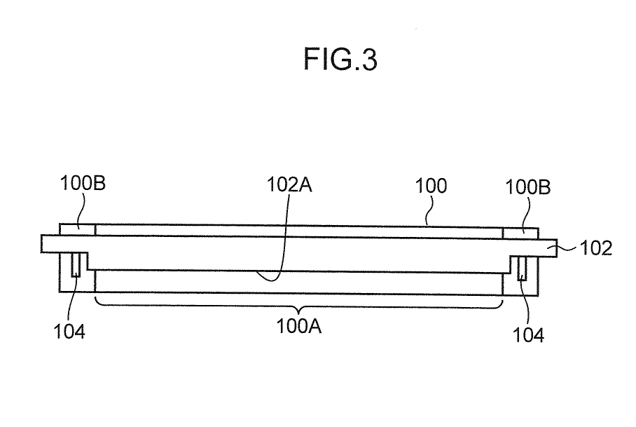

At the opposite ends of the separating member 102, a pair of touching members (contact portion) 104 are arranged to secure the gap G between the tip portion 102A and the circumferential surface of the fixing roller 100. FIG. 3 is a view showing an example of a positional relationship between the touching members 104 and the fixing roller 100. The touching members 104 are members arranged to project forward from the tip portion 102A of the separating member 102, and form the gap G by being held in contact with the circumferential surface of the fixing roller 100.

A passage area 100A where a sheet passes is set on the circumferential surface of the fixing roller 100. Non-passage areas 100B where no sheet passes are set at the opposite ends of the passage area 100A. The touching members 104 are held in contact with the non-passage areas 100B to form the gap G between the tip portion 102A and the circumferential surface of the fixing roller 100.

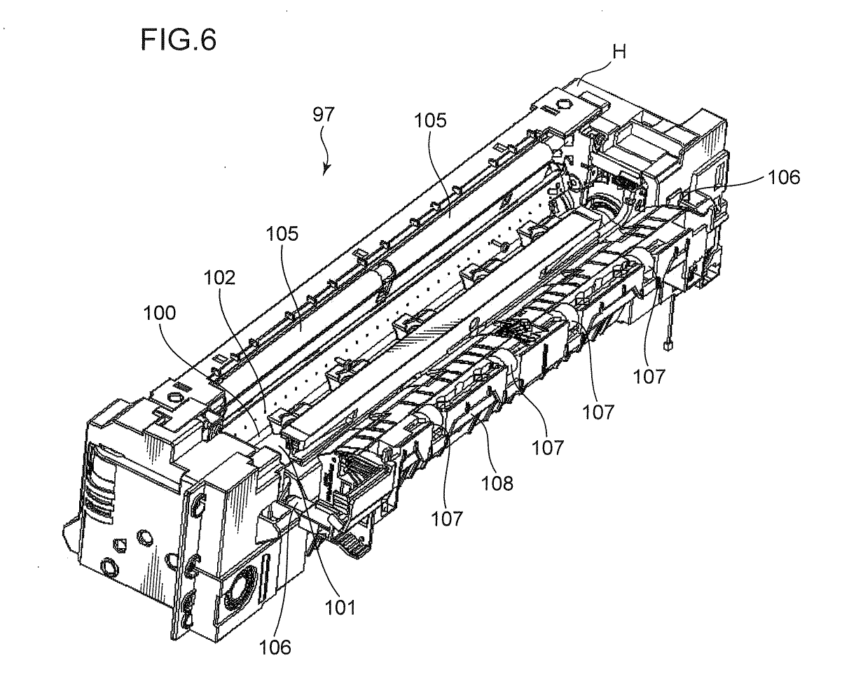

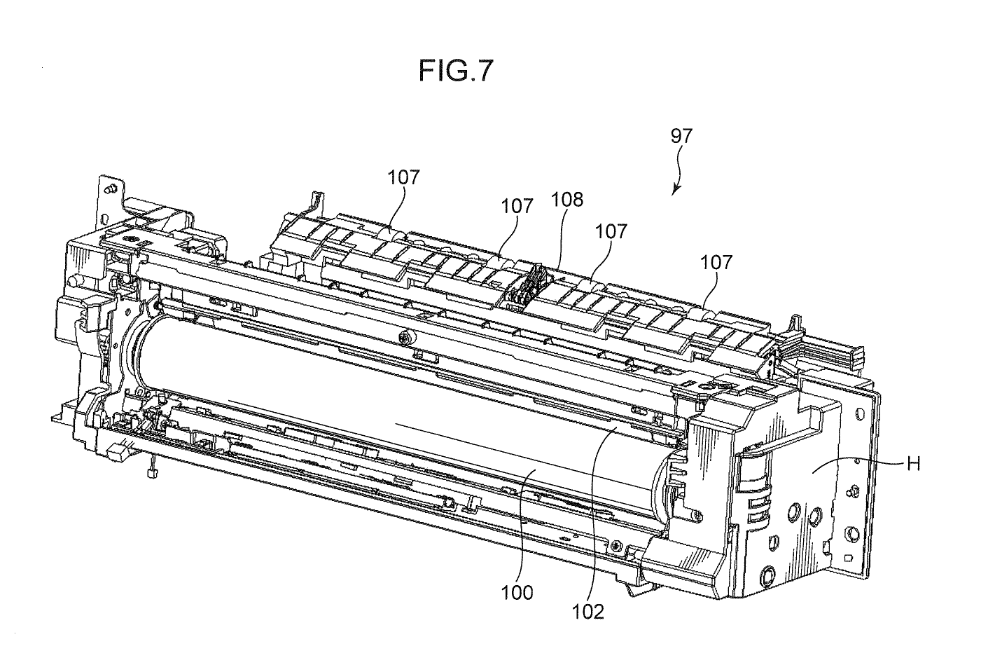

Referring back to FIG. 2, conveyor rollers 105 for conveying a sheet having passed the fixing nip portion N toward a subsequent member (e.g. discharge port 961) are arranged downstream of the separating member 102 in the conveying direction. The conveyor rollers 105 are held in contact with conveyor rollers 107 to be described later (see FIGS. 6 and 7) to form a discharge nip portion.

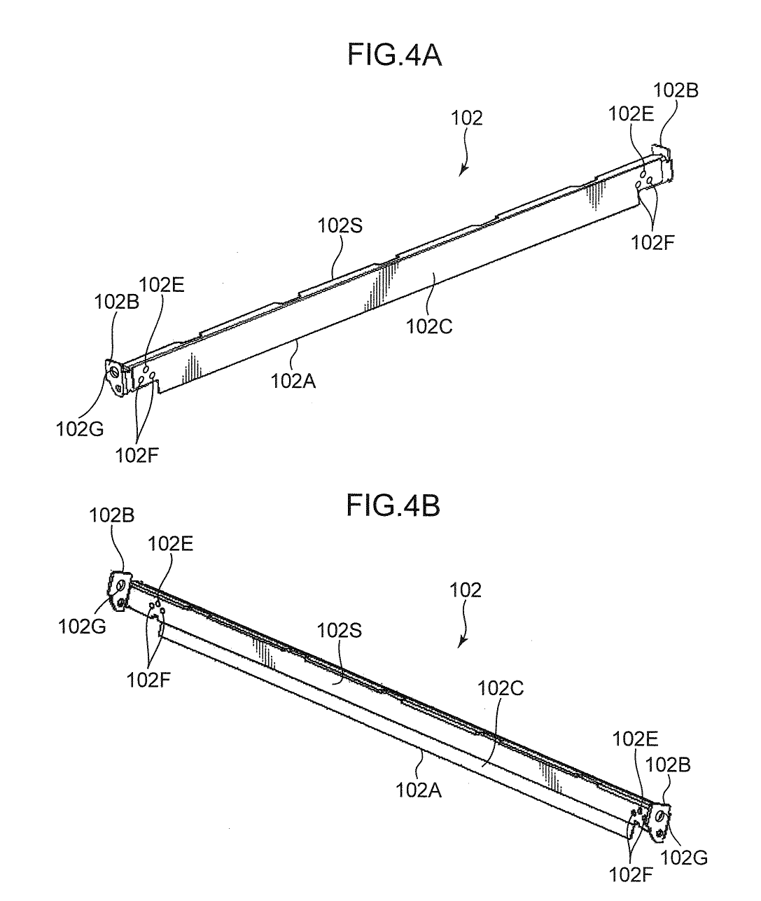

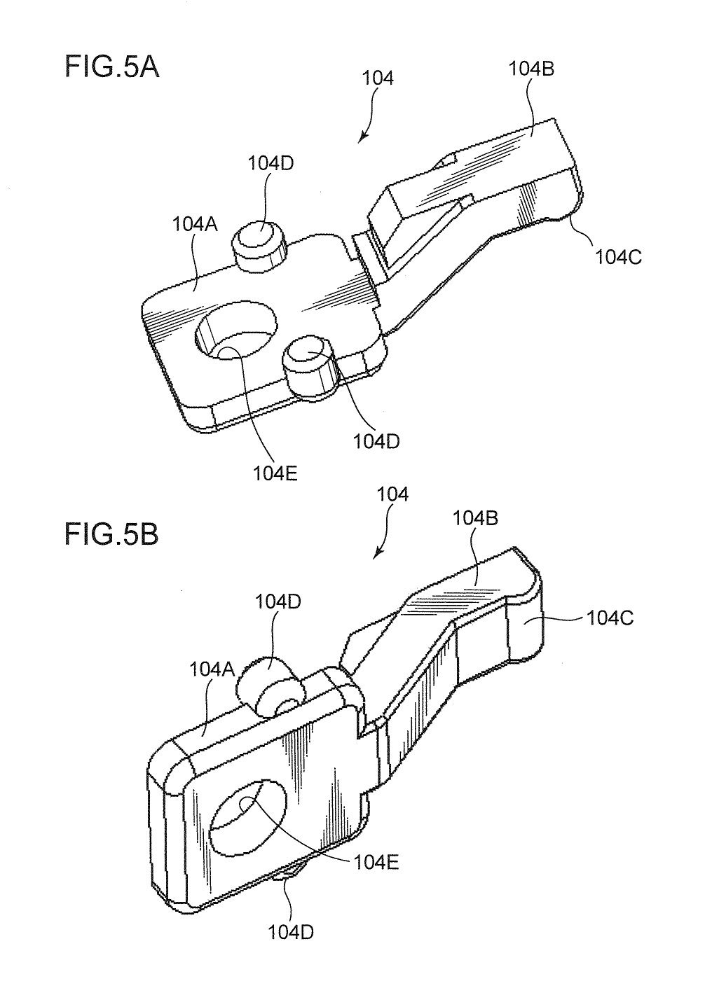

FIGS. 4A and 4B are perspective views showing an example of the construction of the separating member 102. FIG. 4A shows the front side of the separating member 102 and FIG. 4B shows the rear side (side facing the fixing roller 100) of the separating member 102. FIGS. 5A and 5B are perspective views showing an example of the construction of the touching member 104. FIG. 5A shows the front side of the touching member 104 and FIG. 5B shows the rear side of the touching member 104.

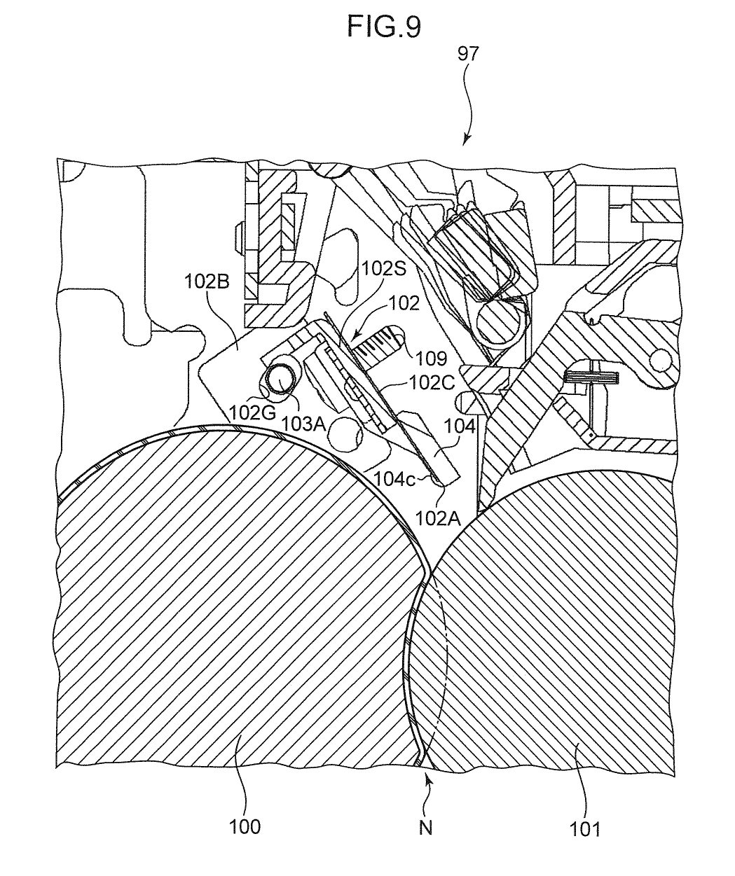

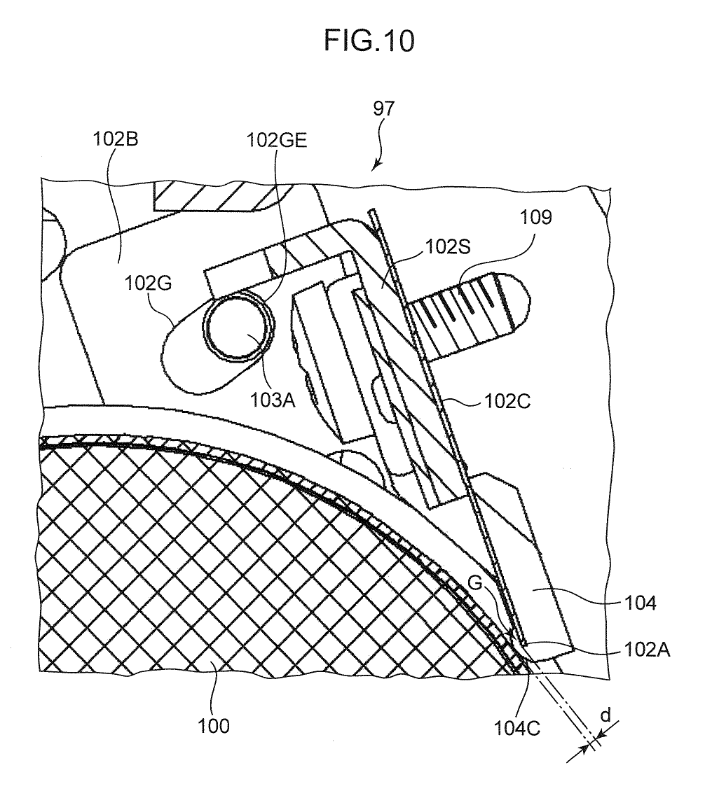

As shown in FIG. 4, the separating member 102 includes a main body 102C in the form of a thin flat plate extending in the axial direction of the fixing roller 100 and a holding plate 102S for holding this main body 102C. The lower end edge of the main body 102C is the aforementioned tip portion 102A. The holding plate 102S has a holing flat surface extending in the axial direction of the fixing roller 100. The main body 102C is held in close contact with the holding flat surface, and the tip portion 102A projects from the lower end of the holding plate 102S (see FIGS. 9 and 10).

Screw holes 102E and through holes 102F used to mount the touching members 104 on the separating member 102 and mount the holding plate 102S on the main body 102C are provided at the opposite ends of the holding plate 102S. The main body 102C is also perforated with holes corresponding to the through holes 102F and screw holes 104E to be described later. Further, a pair of end plates 102B supported by the supporting members 103 are provided at the opposite ends of the holding plate 102S. The respective end plates 102B are parts bent at right angles to the holding flat surface of the holding plate 102S and are formed with long holes 102G. The long holes 102G are arranged on the base end side of the separating member 102 and so perforated as to support the separating member 102 rotatably about an axis parallel to the axial direction of the fixing roller 100.

As shown in FIG. 5, the touching member 104 includes a mounting portion 104A to be mounted on each of the opposite ends of the holding plate 102S of the separating member 102. The mounting portion 104A includes the screw hole 104E used to mount the touching member 104 on the holding plate 102S of the separating member 102. Further, a pair of positioning pins 104D for positioning and mounting the touching member 104 on the holding plate 102S of the separating member 102 project on the lateral edges of the mounting portion 104A at the opposite sides of the screw hole 104E.

A main body 104B having a bent shape is connected to the mounting portion 104A. A touching portion 104C to be brought into contact with the circumferential surface of the fixing roller 100 projects at the tip of the main body 104B.

In mounting the touching members 104 on the separating member 102, the front sides (sides exposed in FIG. 5A) of the mounting portions 104A of the touching members 104 are first brought into contact with the opposite ends of the rear side (side exposed in FIG. 4B) of the holding plate 102S of the separating member 102.

Then, the positioning pins 104D of the touching members 104 are inserted into the through holes 102F of the holding plate 102S and mounting screws 109 (see FIGS. 9 and 10) are threadably inserted into the screw holes 104E of the touching members 104 and the screw holes 102E of the separating member 102 from the rear side of the separating member 102. The touching members 104 are mounted on the separating member 102 in the above manner.

FIG. 6 is a perspective view of the fixing unit 97 when viewed from behind. FIG. 7 is a perspective view of the fixing unit 97 when viewed from front. Note that, in FIGS. 6 and 7, the front side means a side where the fixing roller 100 is arranged and the back side means a side opposite to the one where the fixing roller 100 is arranged.

The fixing unit 97 includes a fixing housing H. The fixing roller 100, the pressure roller 101, the separating member 102, the supporting members 103, the touching members 104 and the conveyor rollers 105 are housed in the fixing housing H.

Further, a cover member 108 which rotates about a pivot point 106 is arranged in the fixing unit 97. The cover member 108 is openable and closable relative to the fixing housing H by rotating about the pivot point 106. Note that the cover member 108 is open relative to the fixing housing H in FIGS. 6 and 7.

The conveyor rollers 107 are arranged on the cover member 108. The conveyor rollers 107 come into contact with the conveyor rollers 105 to form the discharge nip portion when the cover member 108 is closed relative to the fixing housing H.

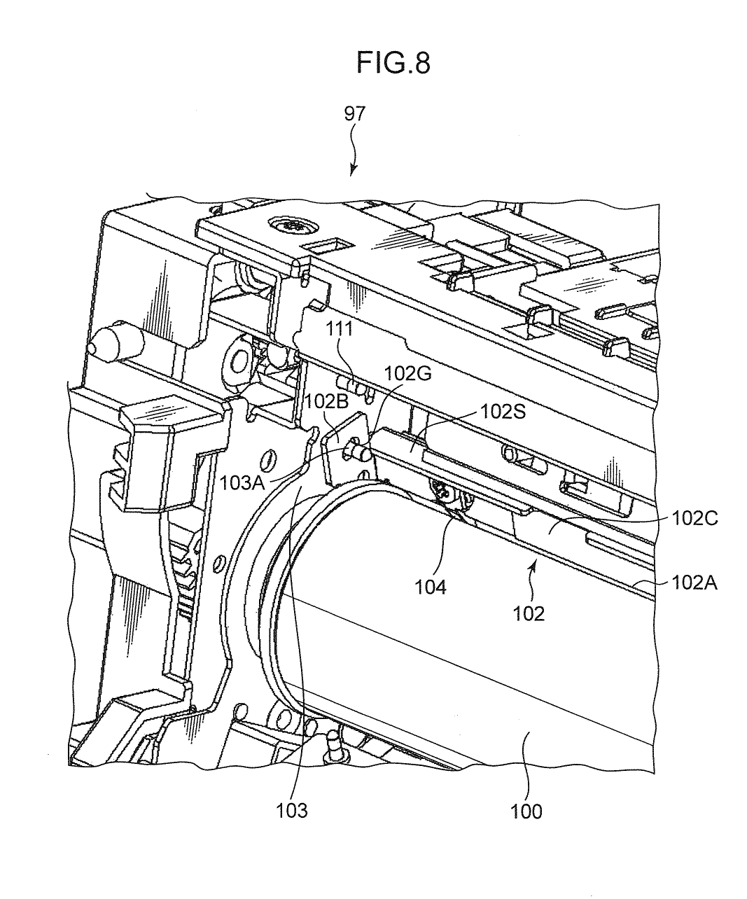

FIG. 8 is a perspective view showing an example of a mounting mode of the separating member 102 on the supporting member 103. In the fixing unit 97, a pivot member 103A stands on the supporting member 103. The pivot member 103A is a cylindrical member. Note that only the supporting member 103 on one end of the fixing roller 100 is shown and the supporting member 103 on the other end of the fixing roller 100 is not shown in FIG. 8.

The pivot members 103A are inserted into the long holes 102G perforated in the end plates 102B of the separating member 102. This enables the separating member 102 to rotate about the axis of the pivot members 103A. As a result, the separating member 102 is displaceable between a first posture in which the tip portion 102A of the separating member 102 is close to the circumferential surface of a fixing belt 50 and a second posture in which the tip portion 102A is separated from the circumferential surface of the fixing belt 50.

The separating member 102 is rotatably supported by inserting the cylindrical pivot members 103A into the long holes 102G. Accordingly, the separating member 102 can move in parallel in the stroke range of the long holes 102G. Thus, even if there is a deviation in parallelism between the tip portion 102A of the separating member 102 and the shaft of the fixing roller 100, the touching portions 104C come into contact with the circumferential surface of the fixing belt 50, whereby the pivot position of the separating member 102 shifts in the long holes 102G to correct the deviation. Therefore, parallelism between the tip portion 102A and the circumferential surface of the fixing roller 100 can be maintained.

As described above, the separating member 102 is mounted rotatably relative to the supporting members 103 by inserting the pivot members 103A of the supporting member 103 into the long holes 102G perforated in the end plates 102B. In this embodiment, a supporting mechanism for the separating member 102 is formed by the end plates 102B and the supporting members 103.

FIG. 9 is a sectional view of an essential part of the fixing roller 97 showing a state where the tip (touching portion 104C) of the touching member 104 is separated from the circumferential surface of the fixing roller 100 (second posture) and FIG. 10 is a sectional view showing a state where the tip of the touching member 104 is in contact with the circumferential surface of the fixing roller 100 (first posture). In FIGS. 9 and 10 is shown the mounting screw 109 used to mount the touching member 104 on the separating member 102.

In FIG. 9, the fixing roller 100 rotates in a counterclockwise direction and the pressure roller 101 rotates in a clockwise direction. Since the circumferential surface of the pressure roller 101 is made of a material harder than the circumferential surface of the fixing roller 100, the circumferential surface of the pressure roller 101 is pressed by the circumferential surface of the fixing roller 100 in the fixing nip portion N. The separating member 102 is arranged downstream of the fixing nip portion N in the rotation direction of the fixing roller 100.

The touching portion 104C of the touching member 104 is not in contact with the circumferential surface of the fixing roller 100 in the second posture shown in FIG. 9, whereas the touching portion 104C is in contact with the circumferential surface of the fixing roller 100 in the first posture shown in FIG. 10. In the state where the touching member 104 is in contact with the circumferential surface of the fixing roller 100, the gap G of the distance d is formed between the tip portion 102A of the separating member 102 and the circumferential surface of the fixing roller 100.

In FIG. 10, the pivot member 103A is in contact with an end edge GE on a side of the long hole 102G distant from the fixing roller 100. Such a contact can be achieved by providing a biasing spring (biasing member) for biasing the touching member 104 mounted on the separating member 102 toward the circumferential surface of the fixing roller 100.

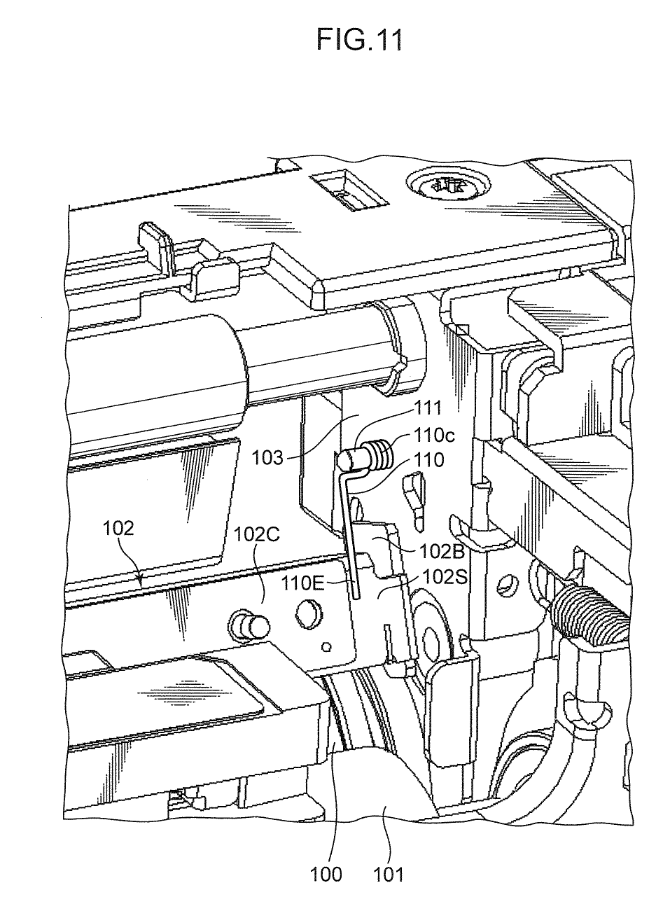

FIG. 11 is a view showing an example of a mounting mode of the biasing spring 110. Note that although the biasing spring 110 at one end of the fixing roller 100 is shown in FIG. 11, a similar construction is provided at the other end of the fixing roller 100, but neither described nor shown. The biasing spring 110 is a torsion coil spring including a cylindrical coil portion 110C and a bar-shaped locking portion 110E connected to this coil portion 110C.

A cylindrical portion 111 extends from the supporting member 103 in a direction parallel to the axial direction of the fixing roller 100. The coil portion 110C of the biasing spring 110 is mounted on this cylindrical portion 111. The locking portion 110E is held in contact with the front side of the main body 102C of the separating member 102 with a biasing force. This causes a biasing force to be given to the separating member 102 such that the tip portion 102A of the main body 102C rotates about the axis of the above pivot member 103A in a direction toward the circumferential surface of the fixing roller 100. By this biasing force, the touching member 104 mounted on the separating member 102 is pressed against the circumferential surface of the fixing roller 100 and reliably held in contact with the circumferential surface of the fixing belt 50.

As described above, according to the fixing roller 97 of this embodiment, the touching members 104 provided on the separating member 102 come into contact with the circumferential surface of the fixing roller 100, thereby forming the gap G of the predetermined distance between the separating member 102 and the fixing roller 100. Accordingly, as long as the touching members 104 are in contact with the circumferential surface of the fixing roller 100, the gap G can be appropriately secured. Further, since the touching members 104 are in contact with the non-passage areas 100B of the circumferential surface of the fixing roller 100 where no sheet passes, there is no likelihood of leaving a mark of damage in a toner image on a sheet.

Further, since the separating member 102 is supported on the supporting members 103 by inserting the pivot members 103A into the long holes 102G provided in the separating member 102, the pivot of the separating member 102 is not fixed and can be shifted in the range of the long holes 102G. Thus, even if the fixing roller 100 is displaced, the pivot members 103A move in the long holes 102G, whereby parallelism between the separating member 102 and the axis of the fixing roller 100 can be maintained and the gap G can be appropriately secured.

Furthermore, since the biasing springs 110 can reliably bring the touching members 104 into contact with the circumferential surface of the fixing roller 100, the gap G can be more appropriately secured.

Although the contact portion is formed by mounting the touching members 104 on the separating member 102 in this embodiment, it is not limited to this example. For example, a contact portion may be formed using a part of the separating member 102 such as by bending a part of the main body 102C toward the circumferential surface of the fixing roller 100.

Although the present disclosure has been fully described by way of example with reference to the accompanying drawings, it is to be understood that various changes and modifications will be apparent to those skilled in the art. Therefore, unless otherwise such changes and modifications depart from the scope of the present disclosure hereinafter defined, they should be construed as being included therein.

What is claimed is:

1. A fixing device, comprising:
a first and a second rollers which form a fixing nip portion and fix a toner image formed on a sheet passing the fixing nip portion by heating and pressing the sheet;
a separating member which is a plat-like member arranged downstream of the fixing nip portion in a rotation direction of the first roller, adapted to separate the sheet having passed the fixing nip portion while wrapping around the first roller from the first roller and extending in an axial direction of the first roller; and
a supporting mechanism which rotatably supports the separating member such that the separating member is displaced between a first posture in which the tip of the separating member is close to the circumferential surface of the first roller and a second posture in which the tip is distant from the circumferential surface of the first roller;
wherein:
a passage area where the sheet passes and a non-passage area where the sheet does not pass are set on the circumferential surface of the first roller;
the separating member includes a contact portion which comes into contact with the non-passage area to form a gap of a predetermined distance between the tip of the separating member and the circumferential surface of the first roller;
the contact portion is a touching member which is so mounted on the opposite ends of the plate-like member as to at least partly project toward the circumferential surface of the first roller; and
the supporting mechanism includes a pivot member which serves as a pivot of rotation of the separating member and a long hole which is formed in the separating member and into which the pivot member is inserted.

2. A fixing device according to claim 1, further comprising a biasing member for biasing the contact portion toward the non-passage area of the first roller.

3. An image forming apparatus, comprising:
a fixing device according to claim 1;
an image obtaining unit for obtaining image data of a document; and
an image forming unit for forming the image data obtained by the image obtaining unit on a sheet.

4. A fixing device, comprising:
a first and a second rollers which form a fixing nip portion;
a separating member which is a plat-like member arranged downstream of the fixing nip portion in a rotation direction of the first roller and extending in an axial direction of the first roller;
a supporting mechanism which rotatably supports the separating member such that the separating member is displaced between a first posture in which the tip of the separating member is close to the circumferential surface of the first roller and a second posture in which the tip is distant from the circumferential surface of the first roller; and
a contact portion which is provided on the separating member and comes into contact with the circumferential surface near the opposite ends of the first roller in the first posture to form a gap of a predetermined distance between the tip of the separating member and the circumferential surface of the first roller;
wherein:
the supporting mechanism includes:
a pair of supporting members arranged near the opposite ends of the first roller;
pivot members extending from the supporting members and serving as a pivot of rotation of the separating member; and
long holes which are provided at the opposite ends of the separating member and into which the pivot members are inserted.

5. A fixing device according to claim 4, wherein:
the separating member includes a main body in the form of a thin flat plate extending in the axial direction of the first roller, a holding plate for holding the main body, and a pair of end plates provided on the opposite ends of the holding plate; and
the long hole is provided in each of the pair of end plates.

6. A fixing device according to claim 5, wherein the contact portion is a touching member which is so mounted on the opposite ends of the holding plate of the separating member as to at least partly project toward the circumferential surface of the first roller.

7. A fixing device according to claim 5, further comprising a biasing member for biasing the contact portion toward the first roller, the biasing member being a coil spring held on the supporting members.

8. A fixing device according to claim 4, wherein the opposite ends of the first roller with which the contact portion is in contact are non-passage areas where a sheet passing the fixing nip portion does not pass.
